(19) United States
(12) Patent Application Publication
(10) Pub. No.: US 2001/0031016 A1
(43) Pub. Date: Oct. 18, 2001

(54) Enhanced bitloading for multicarrier communication channel

(76) Inventor: Ernest Seagraves, Fremont, CA (US)

Correspondence Address: FENWICK & WEST LLP, TWO PALO ALTO SQUARE, PALO ALTO, CA, 94306, US

(21) Appl. No.: 09/804,676

(22) Filed: Mar. 12, 2001

Related U.S. Application Data
(60) Provisional application No. 60/189,209, filed on Mar. 14, 2000.

(51) Int. Cl. H04L 5/12

(52) U.S. Cl. 375/264; 370/431

(57) ABSTRACT

Techniques for identifying an improved bitloading assignment for a multicarrier communication channel are provided. Generally, bit loadings of the sub-channels are equalized (either completely or partially) by selectively decrementing high bitload sub-channels until a desired degree of equalization between the sub-channel bit loadings is achieved. By reducing the bit loading of high bitload sub-channels relative to other sub-channels, the communication channel is effectively desensitized to non-stationary noise.

### CROSS-REFERENCES TO RELATED APPLICATIONS

This application claims the benefit of U.S. Provisional Application No. 60/189,209, filed on Mar. 14, 2000, which is herein incorporated by reference.

### FIELD OF THE INVENTION

This invention relates to communication systems, and more particularly, to performing bitloading for multicarrier communication channels subject to non-stationary noise.

### BACKGROUND OF THE INVENTION

The Telecommunications Standards Section of the International Telecommunication Union (designated as ITU-T) provides recommendations to facilitate the standardization of the telecommunications industry. Two of these recommendations are designated G.992.1 and G.992.2, respectively. Recommendation G.992.1 refers to an asymmetric digital subscriber line (ADSL) transceiver that is an ADSL industry standard for network access at rates up to 8.192 mbit/s downstream (toward subscriber) and 640 kbit/s upstream (toward central office or network administrator). Recommendation G.992.2, on the other hand, refers to an ADSL transceiver that is a lower data rate version of a G.992.1 ADSL transceiver. Bit rates up to 1.5 mbit/s in the downstream direction and 512 kbit/s upstream are possible with this standard. In general, such transceivers are prevalent because they offer practical solutions to communicating data over high traffic networks such as the Internet.

Both G.992.1 and G.992.2 have an Annex C that defines a special recommendation for ADSL transceivers under the time compression multiplexing—integrated services digital network (TCM-ISDN) noise environment. Each of these respective Annexes is herein incorporated by reference in its entirety. Reference to “Annex C” may be to either or both of G.992.1 and G.992.2. TCM-ISDN is defined in ITU-T recommendation G.961 Appendix III. This recommendation is also herein incorporated by reference in its entirety. Recommendation G.961 Appendix III describes a ping-pong scheme where the transmission (and reception) of data between two transceivers is performed under the control of a 400 Hz clock referred to as the TCM-ISDN timing reference (TTR). G.992.1 and G.992.2 Annex C transceivers transmit and receive signals based on this TTR signal. For example, the central office transceiver transmits the data stream in the first half of the TTR period, and the customer transceiver transmits basically in the second half of the TTR period. Such a ping pong scheme is particularly useful in the context of a communication channel that has high crosstalk interference levels due to the likes of poor quality insulators (e.g., pulp based insulation) within a cable bundle thereby rendering simultaneous transmission from both the central office and customer transceivers impractical.

The G.992.1 and G.992.2 standards are similar to one another in that they both use a multicarrier modulation scheme referred to as discrete multi-tone (DMT) modulation technology. DMT modulation employs multiple carriers for both upstream and downstream communication. In such multicarrier type systems, frequency-division-multiplexing is often used, where upstream and downstream communication use carriers in different frequency bands, while spectrum overlapping is also possible by using echo cancellers as is known in the art. By working with a large number of carriers rather than a single carrier, the available channel capacity can be maximized thereby optimizing performance of the transmission bandwidth.

A bitloading algorithm can be employed to ensure that each carrier operates at its optimal loading given a predefined performance margin and desired bit error rate (BER). Various conventional bitloading techniques are available. For example, a water-pouring technique can be employed to achieve an optimal energy distribution for a DMT-based channel. However, such a technique involves difficult computations (especially in DSL applications), and impractically assumes infinite granularity in signal constellation size. The Hughes-Hartogs technique, on the other hand, provides a finite-granularity DMT-based loading algorithm, but at the expense of increased processing time, particularly in ADSL applications.

Other conventional bitloading techniques involve an iterative algorithm that attempts to equalize the system noise margin on a bin-by-bin basis given a specified BER (e.g., 10⁻⁷). Thus, a constant noise margin is assumed for all bins. While such techniques may provide an optimal solution under stationary noise (e.g., additive white Gaussian noise—AWGN), they provide a sub-optimal solution against non-stationary noise (e.g., impulse noise). For instance, the impact of non-stationary noise on each bin of a channel is, in general, related to the SNR of each bin. Bins having a greater capacity (e.g., peak portion of SNR curve) are more adversely affected by such noise in comparison to bins having a relatively lower capacity (e.g., trough portion of SNR curve). This situation is of particular concern when the channel impairment associated with non-stationary noise causes the SNR to be reduced to an amount greater than the noise margin causing the BER to rise above the target BER (e.g., 10⁻⁷).

What is needed, therefore, is a technique for providing improved bitloading for a multicarrier communication channel in the presence of non-stationary noise.

### SUMMARY OF THE INVENTION

One embodiment of the present invention provides a method for identifying a bitloading assignment for a multicarrier communication channel having a number of sub-channels and a disposable bit capacity of one or more bits. The method includes identifying a sub-channel having a maximum bit loading relative to bit loadings of other sub-channels, decrementing the bit loading of the identified sub-channel by at least one bit thereby reducing bit loading differences between the identified sub-channel and the other sub-channels, and decrementing the disposable bit capacity by the number of bits the identified sub-channel loading was decremented. The identifying step and the decrementing steps may be repeated until a desired degree of equalization between the sub-channel bit loadings is achieved (e.g., the disposable bit capacity is zero) thereby producing a bitloading assignment for the multicarrier communication channel.

Another embodiment of the present invention provides a transceiver for identifying a bitloading assignment for a multicarrier communication channel having a number of sub-channels and a disposable bit capacity of one or more bits. The transceiver includes a bitloading assignment module for generating the bitloading assignments of the sub-channels by selectively decrementing high bitload sub-channels until a desired degree of equalization between the sub-channel bit loadings is achieved (e.g., until the disposable bit capacity is zero). A bitloading assignment for the multicarrier communication channel is produced.

These and other embodiments are described in the detailed description of the invention section. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the inventive subject matter.

### BRIEF DESCRIPTION OF THE DRAWINGS

FIG. 1 is a block diagram of an ADSL transceiver that can perform bitloading in accordance with one embodiment of the present invention.

FIG. 2a illustrates a timing diagram for a TCM-ISDN transmission line.

FIG. 2b illustrates a diagram of interference at a central office from several ISDN lines transmitting in synchronization.

FIG. 3 illustrates a relationship between sub-channel capacity and signal to noise ratio in a multicarrier communication system.

FIG. 4 is a flow chart illustrating a method for identifying an improved bitloading assignment for a multicarrier communication system in accordance with one embodiment of the present invention.

### DETAILED DESCRIPTION OF THE INVENTION

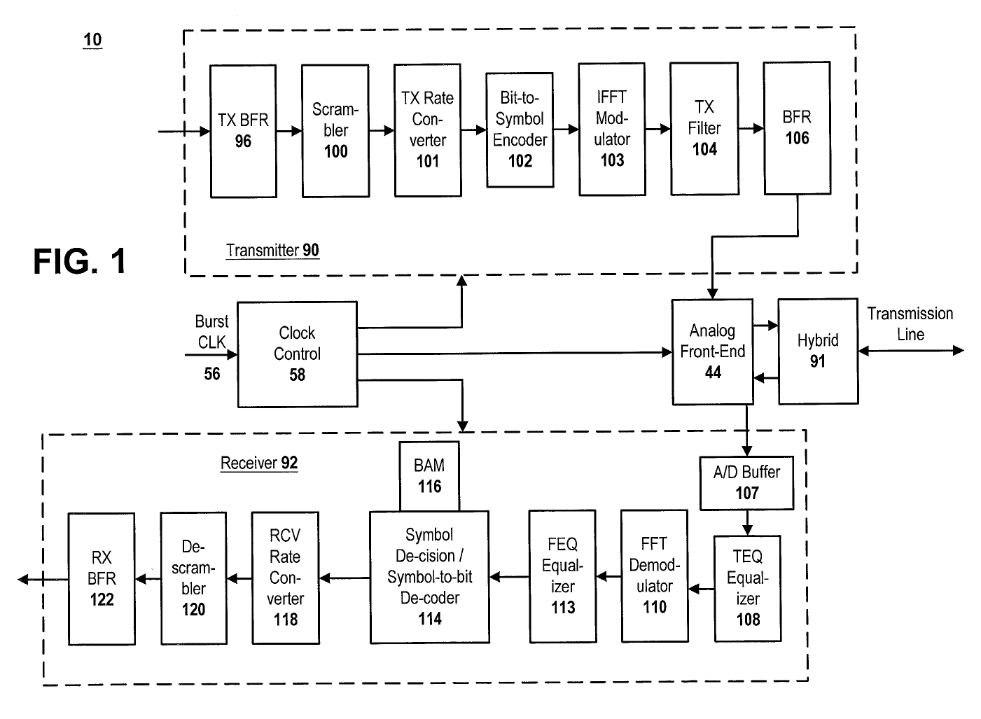

FIG. 1 is a block diagram of an ADSL transceiver that can perform bitloading in accordance with one embodiment of the present invention. Transceiver 10 is comprised of a transmitter 90, an analog front-end 44, a hybrid circuit 91, a clock control unit 58, and a receiver 92. One or more of the functions shown in FIG. 1 may be implemented by a digital signal processor (DSP). For example, transmitter 90 and or receiver 92 can be effected by DSP technology. Additionally, one or more of the functions shown in FIG. 1 may be implemented in software, hardware, firmware, or any combination thereof. Those skilled in the art will appreciate that although the components comprising transceiver 10 are depicted as individual units, any combination of the components may also be implemented in a single discrete unit. For example, transmitter 90 and receiver 92 can be implemented in a single DSP chip or chip set. Transceiver 10 can be used either at the customer premises or at the central office. The central office implementation is shown in the example.

Overview

Hybrid circuit 91 performs 2-to-4-wire conversion thereby converting the bi-directional two-wire signal from the transmission line into two pairs of one-directional transmissions. One pair is for receiving and the other pair is for transmitting. Hybrid circuit 90 can include a splitter to filter-out undesired signals outside the desired transmission band. For example, the low frequency plain old telephone service (POTS) signal can be blocked by the splitter so that the POTS signal will not interfere with the high frequency ADSL signal, as is well known in the art. Hybrid circuit 91 may also include an isolation transformer for isolating the electronics of transceiver 10 from the transmission line.

Analog front-end 44 includes an analog-to-digital (A/D) converter and a digital-to-analog (D/A) converter (neither converter is shown). The separated, filtered signal received by analog front-end 44 from hybrid circuit 91 is converted from analog to digital by the A/D converter, and is sent to receiver 92. Analog front-end 44 may further comprise a gain adjust module for optimizing the signal sent to receiver 92. The output from transmitter 90, on the other hand, is converted from digital to analog by the D/A converter in analog front-end 44, and is filtered and sent to hybrid circuit 91.

Transmitter

Transmitter 90 is comprised of a transmit buffer 96, a scrambler 100, a transmitter rate converter 101, a bit-to-symbol encoder 102, an IFFT modulator 103, a transmitter filter 104 and a buffer 106. Data ready for transmission is received from the customer's data terminal equipment or from the telephone company's network, and is buffered by transmit buffer 96.

Scrambler 100 operates on the input data bits in order to randomize the data pattern. Such randomizing is for optimizing the transmission performance. Scrambling also minimizes the possibility of repetitive data patterns. In one embodiment, scrambler 100 is further combined with a forward error correction (FEC) encoder module and an interleaver module. Such modules can be implemented to further ensure a robust and efficient transmission, as is well known in the art.

Transmitter rate converter 101 can be used to insert dummy bits into the scrambled data stream to equalize the difference between the user data rate, which is typically a multiple of 32 kilobits per second (kbps), and the physical layer data rate, which is not necessarily a multiple of 32 kbps.

Bit-to-symbol encoder 102 receives sequences of bits from transmitter rate converter 101 and encodes them as signal points in a signal constellation. This process is generally referred to as bitloading. For QAM modulation, a two-dimensional signal constellation is used where each signal point in the constellation has an in-phase component and a quadrature component. Depending on the signal constellation size of each sub-channel, each symbol carries multiple bits. For example, 64-QAM has 64 signal points in the constellation, meaning that in each symbol, a sub-channel can carry six binary bits. An even bigger signal constellation (e.g., 128 point constellation) may be used to carry more bits per symbol. The total number of bits transmitted is the sum of the number of bits transmitted by each sub-channel. In one embodiment, bit-to-symbol encoder 102 further includes a convolutional encoder module for obtaining the coding gain. Bit-to-symbol encoder 102 may alternatively include (or have access to) a bitloading assignment module 116, which produces a bitloading assignment in accordance with the present invention. This bitloading assignment module 116 will be explained in the context of receiver 92.

The bit-to-symbol encoder 102 is followed by IFFT modulator 103 that modulates the signal constellations (e.g., QAM constellations) on to the available transmission sub-channels and combines all the sub-channels together for transmission.

The transmission rate of transmitter 90 is a function of the total number of bits per symbol and the symbol rate. For example, using 96 sub-channels with each sub-channel carrying 8 bits per symbol, at a 4 K-baud symbol rate, a transmission rate of 4×96×8=3072 kbit/second is achieved. Due to TCM-ISDN noise, if the FEXT bitmap mode is used, each transmission direction sends data in only 126/340=37% of the time. Hence, the average transmission rate in the example case above is 1138 kbps≈1120 kbps (rounded to the nearest multiple of 32 kbps). Thus, a user data rate of 1120 kbps can be achieved, while the physical layer data rate is 1138 kbps. Dummy bits inserted by transmitter rate converter 101 compensate for the difference between the two rates.

Transmission filter 104 shapes the transmitted signal and reduces out-of-band signal components. A cyclic prefix can be added before the transmission filter 104 to add separation between symbols in order to help the receiver eliminate inter-symbol interference. Buffer 106 stores the filtered samples for transmission. The D/A converter of analog front-end 44 converts the samples to analog signals. Those analog signals can then be filtered, amplified and coupled to the transmission line via hybrid 91.

Clock Control

At the central office, clock control 58 receives burst clock 56 (also referred to as the TCM-ISDN timing reference or TTR) from the central office TCM-ISDN burst-timing control circuit (not shown). The TTR is used to lock the central office transceiver (ATU-C) local clock frequency, which controls the ATU-C A/D and D/A sampling rates, and the transmitter and receiver symbol rates. The ATU-C transmitter also checks the phase of the system TTR, and locks its hyperframe window to the TTR. At the remote transceiver (ATU-R), the receiver tracks the received signal from ATU-C transmitter, and locks the local clock to the ATU-C clock frequency. ATU-R also detects the hyperframe pattern from the received signal from the ATU-C, and aligns its symbol counter to the hyperframe pattern (referred to as hyperframe alignment). The symbol counter is used to track the symbol index, and is incremented by 1 for each symbol. The counter is reset to zero when it reaches 345.

Receiver

Receiver 92 includes an A/D buffer 107, a time-domain equalizer (TEQ) 108, an Fast Fourier Transform (FFT) demodulator 110, a frequency-domain equalizer (FEQ) 113, a symbol decision/symbol-to-bit decoder module 114, a bitloading assignment module (BAM) 116, a receiver rate converter 118, a descrambler 120 and the receiver buffer 122. Data is received from the from the transmission line, processed through hybrid 91 and converted to its digital equivalent by the AD converter of analog front-end 44. A/D buffer 107 receives the digital signal from analog front-end 44.

TEQ 108 compensates for channel distortion in the time-domain such that the combined impulse response of the communication channel and TEQ 108 is within the length of the cyclic prefix. FFT demodulator 110, which is coupled to TEQ 108, separates and demodulates all the sub-channels. The cyclic prefix is removed after TEQ 108.

After FFT demodulator 110, FEQ 113 provides further compensation for amplitude and phase distortion for each carrier (note that carrier can also be referred to as bin or sub-channel). Thus, there is one FEQ 113 for each sub-channel of communication. The equalizer coefficients characterize the distortion of the associated sub-channel and can be used to compensate for that distortion.

Symbol decision/symbol-to-bit decoder module 114 decides which signal point from the signal constellation represents the received signal at each sub-channel. The actual structure of symbol decision/symbol-to-bit decoder module 114 may vary depending on the encoding scheme used by the remote transmitter. For an uncoded system, the symbol decision portion of module 114 may be a slicer. For a Trellis-code modulation system, a Viterbi decoder can be used for symbol decision to improve the reliability of the decision. Generally, the difference between the output of FEQ equalizer 113 and the output of symbol decision is the error signal that can be used to adjust the FEQ coefficients.

Since in each symbol, each sub-channel can encode a series of bits, the symbol-to-bit decoder portion of module 114 converts the symbols to binary bits. Thus, symbol decision/symbol-to-bit decoder module 114 is used to recover the bit stream that was loaded into the transmitted constellations by bit-to-symbol encoder 102 of the remote transceiver's transmitter 90.

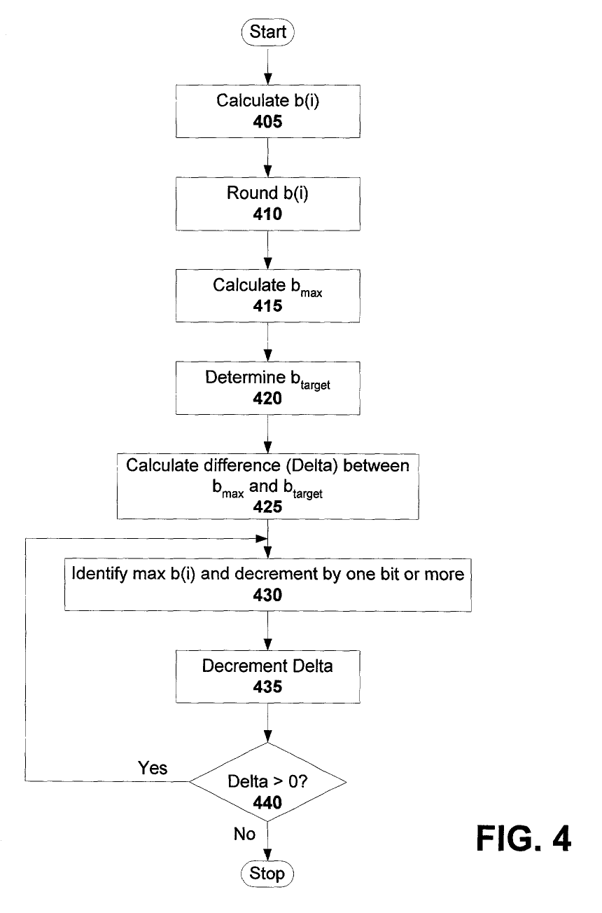

Symbol decision/symbol-to-bit decoder module 114 also includes (or has access to) a bitloading assignment module 116, which improves a bitloading assignment in accordance with the present invention. The functionality of the bitloading assignment module 116 is described in detail with reference to FIG. 4. Although the embodiment illustrated in FIG. 1 shows bitloading assignment module 116 as part of symbol decision/symbol-to-bit decoder module 114, the functionality of bitloading assignment module 116 can be effected in other transceiver components or in a self contained module. Note that the bitloading assignment module 116 could alternatively be operatively coupled to the bit-to-symbol encoder 102 of the transmitter as will be explained.

Receiver rate converter 118 removes dummy bits inserted by the remote transmitter rate converter 101, and passes only user data bits to descrambler 120. Descrambler 120 restores the bits to their original value before they were scrambled by scrambler 100 of the transmitting transceiver. The de-scrambled bit stream is buffered by receive buffer 122 before being sent to a high-speed data network at the central office, or to the customer's data terminal equipment. In one embodiment, descrambler 120 is further combined with a forward error correction (FEC) decoder module and a deinterleaver module to ensure a robust and efficient transmission.

Those skilled in the art will appreciate that transceiver 10 shown in FIG. 1 is only an example of one possible transceiver configuration. Other transceivers may be comprised of components not specifically represented in the figure (e.g., tone ordering module, CRC unit, modulating signal generator). Also, other transceivers may not include the components shown in FIG. 1. In short, the configuration of the transceiver depends on factors such as the particular application (e.g., ADSL-based applications). Also note that, depending on the transceiver's mode of operation (e.g., data mode, TEQ training mode, bitloading optimization mode, FEQ training mode), the various components shown may or may not actually come into play. For example, the scrambler 101, transmit rate converter 101, descrambler 120 and receive rate converter 118 are generally only used in the data mode after transceiver 10 has been trained and equalized. The principles of the present invention can be applied to a number of multicarrier-based systems, and is not intended to be limited to any one particular system or transceiver type.

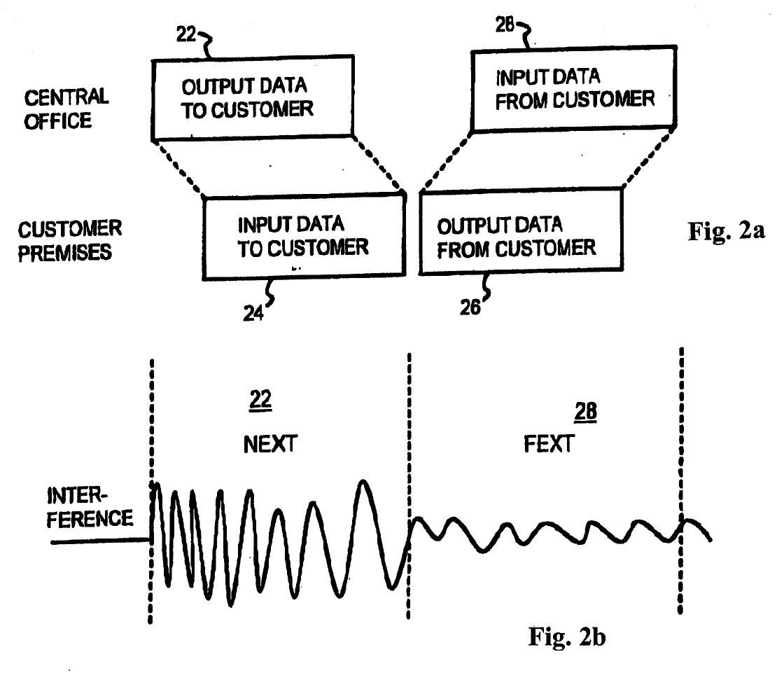

FIG. 2a illustrates a timing diagram for a TCM-ISDN transmission line. During time period or window 22, data is transmitted from a TCM-ISDN transceiver at the central office to the remote TCM-ISDN transceiver at the customer's premises. The downstream data arrives at the remote transceiver of the customer's premises during window 24. A pause occurs after this downstream transmission is complete. This pause is sometimes called the turnaround period of the TTR. During window 26, upstream data is transmitted from the customer's premises transceiver to the remote central office transceiver. The upstream data arrives at the remote transceiver of the central office during reception window 28. At any particular time, only one end of the TCM-ISDN line is transmitting, while the other end is receiving. Echo cancellation is not needed since the echo of the transmitted signal does not have to be removed. While such a TCM-ISDN system is effective for reducing cross-talk in the TCM-ISDN system, ADSL systems operating in the same cable bundle must also perform under the cross-talk from the ISDN lines.

FIG. 2b illustrates an example diagram of crosstalk interference at a central office from several ISDN lines transmitting in synchronization. Crosstalk interference between the various wire-pairs bundled together in a conventional copper transmission line is a major contributor to channel impairment. Generally, crosstalk interference belongs to one of two groups: near end crosstalk (NEXT) and far end crosstalk (FEXT). NEXT is the crosstalk caused by signals in adjacent lines transmitted from the same end of the transmission line, while FEXT is the crosstalk caused by signals in adjacent lines transmitted from the remote end of the transmission line. NEXT is typically much stronger than FEXT. The ADSL symbols under FEXT noise are called FEXT symbols, while all the other symbols are called NEXT symbols.

FEXT bitmap mode Annex C transceivers synchronize the transmission and reception to the TCM-ISDN timing reference (TTR) so that the receiver receives signal in FEXT time where the signal-to-noise ratio is higher, while it receives no signal (e.g., in a FEXT bitmap mode, also referred to as a single bitmap mode) or signal at a lower data rate (e.g., in a dual bitmap mode) in NEXT time where the signal-to-noise ratio is low. As such, the ADSL transceivers function under a TCM-ISDN crosstalk noise environment having a level that changes periodically.

In general, the transceiver of the central office receives NEXT noise from the ISDN in one half of the TTR period (e.g., time period 22) and FEXT noise from the ISDN in the other half of the TTR period (e.g., time period 28). On the other hand, the remote transceiver at the customer's premises receives FEXT noise from the ISDN in the first half of the TTR period and NEXT noise from the ISDN in the second half of the TTR period. As shown in FIGS. 2a and 2b, a burst of data is sent from the central office to the remote sites during time period 22. NEXT is particularly strong at the central office side during transmit period 22 since the transceivers at the central office are all transmitting. During time period 28, these transceivers at the central office are not transmitting, and the interference at the central office is primarily FEXT, which is weaker than NEXT since it is attenuated by the length of the transmission line.

Annex C defines a dual bitmap mode (DBM) encoding method for providing dual bitmaps that are switched synchronized with the hyperframe pattern that is synchronized to the TTR to provide a data stream having dual bit rates. The method is based on the observation that for short local loops (e.g., less than about two kilometers), the channel signal-to-noise ratio (SNR) can be sufficiently high during NEXT interference to transmit data at a low bit rate. Thus, under certain conditions DBM allows full-duplex operation of TCM-IDSN transceivers by employing different bit rates under NEXT and FEXT interference, respectively. In this sense, the communication channel operating under DBM in a TCM-ISDN environment is effectively two communication channels: one is a FEXT channel and the other is a NEXT channel.

For longer local loops, however, the SNR during NEXT time is typically too low for transceivers to send any data. In that case, therefore, the data transmission occurs only in FEXT time. This is referred to as FEXT bitmap mode (FBM) of encoding, also referred to as single bitmap mode (SBM). With FBM encoding, the central office and the remote transceivers are transmitting data only in FEXT time, and do not transmit data simultaneously (half-duplex mode).

In DBM encoding, bit rates can be changed by changing the bitmaps used to encode the symbols to be transmitted. As is understood by those skilled in the art, a “bitmap” determines the number of bits that can be encoded into each sub-channel in a symbol. A “symbol” is the basic unit of information transmitted by the transceiver. The number of bits encoded into each sub-channel in a symbol is limited by the quality of the communication channel. The quality of the communication channel can be represented by its SNR. Thus, a system employing DBM includes two bitmaps for providing different data rates: one bitmap for NEXT time and one bitmap for FEXT time. A system employing FBM, on the other hand, needs only one bitmap (e.g., a FEXT bitmap) since no data signal is transmitted in NEXT time.

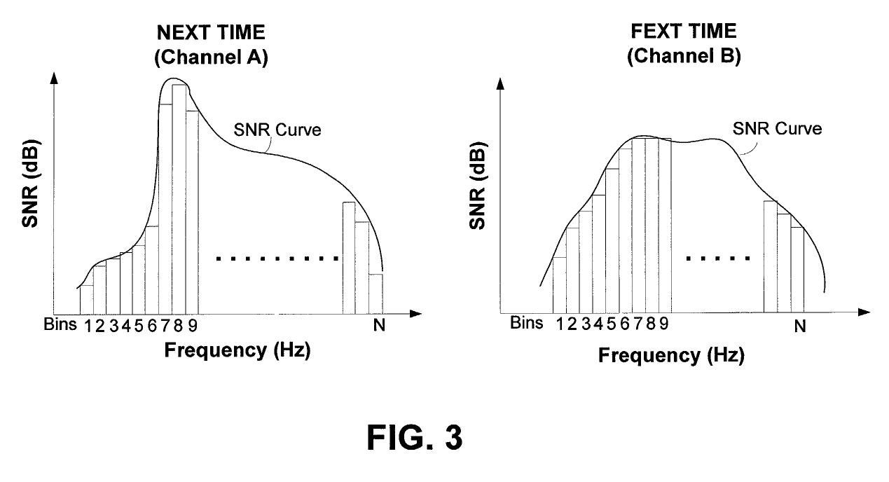

FIG. 3 illustrates FEXT and NEXT bitmaps for a full-duplex communication channel. This communication channel might be effected, for example, by a pair of ADSL Annex C transceivers employing DBM encoding under a TCM-ISDN noise environment. In general, such an ADSL Annex C transceiver pair effectively trains and operates on two different channels. More particularly, the two different channels are really the same channel operating under two different types of crosstalk noise. The first channel (channel A) exists during NEXT time, while the second channel (channel B) exists during FEXT time. Note that other multicarrier communication systems might have only one effective channel.

As shown in FIG. 3, each of these effective channels is associated with a particular SNR curve. This SNR curve or pattern can be characterized by the receiver of one transceiver when it receives a training signal (e.g., Medley transmission signal period of Annex C) from the transmitter of the other transceiver (included in that transceiver pair) during a bitloading training sequence. The maximum number of bits that each sub-channel can carry can then be determined by the receiver based on the SNR corresponding to that sub-channel. Other factors, such as the SNR gap and desired performance margin, may also be used to determine the maximum number of bits that each sub-channel can carry. The resulting pattern of sub-channel bit capacities is the maximum possible bitloading assignment of the communication channel (generally referred to as the initial bitloading assignment herein). This initial bitloading assignment can then be reduced to meet the target service requirement (b_{target}) in accordance with the present invention. The resulting bitloading assignment provides better performance in the presence of non stationary noise and interference.

Note that a bitloading training sequence can be performed for each effective channel. Likewise, bitloading training sequences can be performed for both the upstream and downstream directions. Thus, one bitmap (e.g., NEXT bitmap) is developed for channel A—upstream, and a second bitmap (e.g., FEXT bitmap) is developed for channel B—upstream. Likewise, one bitmap (e.g., NEXT bitmap) is developed for channel A—downstream, and a second bitmap (e.g., FEXT bitmap) is developed for channel B—downstream.

As each effective channel has its own unique bitmap, each effective channel has a unique overall capacity, where the associated sub-channels (bins) are each capable of carrying a certain number of bits. Thus, each channel has a unique maximum bitloading assignment depending on the capacity of its associated bins. One embodiment of the present invention allocates the bits to be transmitted between channels A and B so as to equalize the number of bits per sub-channel. In such an embodiment, each unique bitloading assignment makes up a portion of an overall bitloading assignment. For example, channel A's bitloading assignment 2, 2, 4, 3, 2 can be combined with channel B's bitloading assignment 4, 4, 6, 5, 4 to make an overall bitloading assignment of 2, 2, 4, 3, 2, 4, 4, 6, 5, 4. Thus, the unique maximum capacity assignments of channel A and channel B can be processed together as one large bitloading assignment process. Once an is overall bitloading assignment is achieved, it can be separated back into two bitloading assignments, one for channel A and one for channel B. Alternatively, bits can be allocated between channels A and B, and then bits can be allocated within channel A and within channel B. Note that the loadings of the bins of a channel (or each effective channel) can be represented in a bit vector to facilitate the bitloading assignment enhancement process in accordance with the present invention.

In an alternative embodiment having only one effective channel, the bitloading assignment process is simplified in that there is no need to allocate bits to be transmitted between two or more channels. Rather, the bits associated with the bins of that one channel could simply be equalized without considering the bit loading of another effective channel.

Note that complete equalization (all bins having the exact same bit loading) may not be possible given factors such as a limited overall channel capacity and a high b_{target} (e.g., desired number of bits per symbol also referred to as target loading). However, a partial equalization of bits in accordance with the present invention can also provide an improved bitloading scheme. Thus, complete equalization is not necessarily the present invention's objective. Rather, and in a general sense, the present invention provides a means for achieving an improved bitloading scheme by reducing the probability of error resulting from non-stationary noise. Such improved bitloading can be achieved with varying degrees of bit loading equalization among the individual sub-channels.

By equalizing (whether partially or completely) the number of bits per sub-channel, the multicarrier communication system can effectively be desensitized to non-stationary noise (e.g., impulse noise). By way of example, assume a channel is comprised of six sub-channels (bins). Further assume that the overall capacity (bₘₐₓ) of the channel is 18 bits, where the respective bit capacities of bins one through six are as follows: bin one has 2 bits, bin two has 4 bits, bin three has 5 bits, bin four has 3 bits, bin five has 2 bits, and bin six has 2 bits for an initial assignment of (2, 4, 5, 3, 2, 2). In addition assume, that the desired b_{target} is 15 bits per symbol. Thus, the channel has a disposable bit capacity of 3 bits.

In accordance with one embodiment of the present invention, the bin having the greatest number of bits loaded is identified, and its loading is reduced to bring that loading in line with the number of bits loaded in other bins of that channel. In the example, bin 3 has the greatest loading at 5 bits. This loading can be reduced in accordance with the present invention thereby yielding the following modified assignment (2, 4, 4, 3, 2, 2). The total bits assigned to this channel is now 17, which is greater than the target of 15 so the process continues. As both bins 2 and 3 now have 4 bits each, either can be reduced by one bit. By choosing bin 2 for reduction, the resulting assignment is (2, 3, 4, 3, 2, 2). The total bit assignment is now 16. Bin 3 now has the maximum of 4 bits and is reduced to 3 resulting in an assignment of (2, 3, 3, 3, 2, 2) with a total of 15. This total now matches the target so the process stops and this is the final bitloading assignment. This reduction can be made one bit at a time, analyzing all the bin loadings after each decrementing iteration so that the next bin for reduction can be identified. Alternatively, the reduction can be made all at once in a single iteration. The granularity of the reduction performed (e.g., bit-by-bit or other) depends on factors such as the number of bins associated with the communication channel, the maximum capacity pattern or bitmap associated with the communication channel, and the processing power of the associated transmitting transceiver.

For ADSL Annex C applications there are two effective channels A and B that are switched between as explained above. One channel is used for a longer duration than the other per the G.992.1 and G.992.2 Annex C specification. In this application, the weighted average of the total bit assignments for both channel A and B needs to match b_{target}. Thus, the equation b_{target}≦b_{target}(A)*x+b_{target}(B)*(1−x) must be satisfied with near equality (e.g., less than 1 bit difference between the two sides of the equation). Also b_{target}(A) must be less than or equal to bₘₐₓ(A) and b_{target}(B) must be less than or equal to bₘₐₓ(B). Since b_{target}, b_{target}(A), and b_{target}(B) are integers, and physical constraints are placed on b_{target}(A) and b_{target}(B), perfect equality cannot always be achieved. When this issue arises, b_{target}(A) and b_{target}(B) are chosen such that the weighted average is slightly larger (e.g., less than one bit larger) than b_{target}. This disposable bit capacity (sometimes referred to as dummy bits) can be discarded at the receiver.

Assume a fractional number x between 0 and 1 to represent the fraction of time channel A is used and let 1−x represent the amount of time channel B is used. Those skilled in the art will understand that x is basically the ratio of FEXT frames in a hyperframe to total frames in a hyperframe (e.g., 128/345). In addition, bₜₒₜₐₗ is the total bits assigned to the channel at any one time, where bₜₒₜₐₗ(A) is the total bits assigned to A channel and bₜₒₜₐₗ(B) is the total bits assigned to the B channel. Also, assume bₜₒₜₐₗ(A) is initialized to bₘₐₓ(A), and bₜₒₜₐₗ(B) is initialized to bₘₐₓ(B).

In this scenario the bitloading assignment problem can be broken down into two problems. First determining how many bits to allocate to channel A and channel B, then allocate those bits to sub-channels within channels A and B. From the equation above using the target total bit assignment b_{target}, the capacities of channels A and B, bₘₐₓ(A) and bₘₐₓ(B), the b_{target} for channels A and B (b_{target}(A) and b_{target}(B)) can be determined. Once b_{target}(A) and b_{target}(B) are determined then the bitloading within channels A and B can proceed independently as two individual bit assignment problems in accordance with the present invention.

The calculation of b_{target}(A) and b_{target}(B) is achieved employing the techniques described herein. The values of bₜₒₜₐₗ(A) and bₜₒₜₐₗ(B) are initialized with bₘₐₓ(A) and bₘₐₓ(B). The largest of bₜₒₜₐₗ(A) or bₜₒₜₐₗ(B) is decremented until x*bₜₒₜₐₗ(A)+(1−x)*bₜₒₜₐₗ(B) is equal to or just larger than b_{target} (e.g., less than one bit larger). Assume that channel A is the FEXT channel and channel B is the FEXT channel. Normally FEXT channel A will be larger than NEXT channel B (assuming FEXT channel A has a better SNR), so FEXT channel A will be decremented until the process stops or until it is equal to NEXT channel B. The decrementing will then ping pong back and forth between channel A and B until b_{target} is met. The choice of which channel (e.g., FEXT channel or the NEXT channel) to decrement is made to maintain a difference between bₜₒₜₐₗ(A) and bₜₒₜₐₗ(B) of 1 bit or less and to minimize the number of dummy bits. The resulting bₜₒₜₐₗ(A) and bₜₒₜₐₗ(B) are the solution b_{target}(A) and b_{target}(B).

Note that decrementing the FEXT channel A decrements bₜₒₜₐₗ by approximately x (e.g., 0.37 bits), and decrementing the NEXT channel B decrements bₜₒₜₐₗ by approximately 1−x (e.g., 0.63 bits). For example, if the difference between bₜₒₜₐₗ and b_{target} is less than 0.63, but greater than 0.37, then only the FEXT channel A can be further decremented to achieve b_{target}. If the difference between bₜₒₜₐₗ and b_{target} is less than 0.37, then neither the FEXT channel A or the NEXT channel B is further decremented. If the difference between bₜₒₜₐₗ and b_{target} is greater than 0.63, then the channel having the greater bₜₒₜₐₗ (whether it be bₜₒₜₐₗ(A) or bₜₒₜₐₗ(B)) is decremented. Once b_{target} is achieved (bₜₒₜₐₗ(A) and bₜₒₜₐₗ(B) are equalized), then the bitloading assignment process within channels A and B proceeds independently as two individual bitloading assignment problems in accordance with the present invention.

Equalizing the bit loadings of the individual bins of a multicarrier channel in accordance with the present invention can be performed in degrees. The degree of bit equalization across the bins of a channel depends on factors such as the number of disposable bits given a desired b_{target} (e.g., desired number of bits per symbol), the maximum number of bits that can be transmitted through the channel (bₘₐₓ) and the desired BER. In one embodiment of the present invention, equalization is performed until the total bits loaded (bₜₒₜₐₗ) is equal to b_{target}. In alternative embodiments, equalization is performed until the bins associated with the communication channel have an optimally improved bitloading assignment given constraints such as depleted disposable bit capacity. In such an embodiment, not all bins have the same bit loading, but maximum capacity bins have had their bitloads reduced thereby reducing the bit loading difference between those bins and other lower capacity bins.

FIG. 4 is a flow chart illustrating a method for identifying an improved bitloading assignment for a multicarrier communication system in accordance with one is embodiment of the present invention. This method can be employed, for example, by a multicarrier communication system that is susceptible to non-stationary noise, such as a DMT-based system. In a more general sense, this method can be applied to any multicarrier communication system having a number of sub-channels, a maximum capacity pattern or bitmap, and a disposable bit capacity of one or more bits. Thus, this method is not intended to be limited to any one particular multicarrier communication system or transceiver type.

The method includes calculating 405 the number of bits that can be transmitted through each sub-channel, which is referred to as b(i). In one embodiment, b(i) is calculated by:

$$b ( i ) = {log}_{2} ( 1 + \frac{SNR ( i )}{Γ \cdot {γ}_{marg in}} )$$

where b is the number of bits for a sub-channel i; SNR is the SNR estimate of a sub-channel i (e.g., based on training signals as explained above); Γ (gamma) is the SNR gap of the chosen system parameters (e.g., bit error rate of 10⁻⁷) for a sub-channel i, and γ_{margin} is the specified system performance margin.

The method may further include rounding 410 b(i) to the nearest whole bit. For example, fractional bits of 0.5 or less are rounded down (e.g., 4.3 bits goes to 4 bits), while fractional bits greater than 0.5 are rounded up (e.g., 4.6 bits goes to 5 bits). The method further includes calculating 415 the maximum number of bits that can be transmitted through the channel (bₘₐₓ) based on the rounded maximum number of bits that can be transmitted by each sub-channel, which can be calculated by:

$${B}_{max} = {\sum }_{i} b ( i )$$

Thus, the summation of the total bits that can be carried by each sub-channel of a particular channel represents the overall capacity of that particular channel.

The method further includes determining 420 the number of bits per symbol or target loading (b_{target}), which can be determined, for example, based on the likes of system configuration options or specified system performance goals. Regardless of how b_{target} is determined, the method further includes calculating 425 the difference between bₘₐₓ and b_{target}, which is referred to as Delta. It is assumed that bₘₐₓ is greater than b_{target}, which indicates that the available overall capacity exceeds the desired b_{target} thereby providing a cushion of disposable bit capacity. In the event that bₘₐₓ is less then b_{target}, then b_{target} must be lowered.

The method proceeds with identifying 430 the bin having the maximum loading (as defined by b(i)), and then decrementing that loading by one bit or more. In the event that more than one bin has the same high loading, then a selection from those particular bins can be made to determine which bin will be decremented. For example, the first bin identified as having the max b(i) could be selected for decrementing. Alternatively, the bin having the smallest round off error (e.g., the difference between b(i) of step 405 and the rounded b(i) of step 410) could be selected for decrementing. Alternatively, the bin associated with a particular frequency range (e.g., the highest or lowest) could be selected for decrementing. Thus, the bin selection in such a case can be based on a predefined selection scheme, whether that selection be arbitrary or based on some quality or characteristics associated with the bin.

Note that the point of decrementing the bins having the greater bitloads is to reduce the difference between the loading of those bins and the loading of the other bins so as to achieve an improved bitloading assignment. Thus, whether the decrementing is performed in one bit increments, two bit increments or N bit increments depends on factors such as the number of bins associated with the communication channel, the target bitload of the communication channel, the maximum capacity pattern or bitmap associated with the communication channel and the processing power of the associated transmitting transceiver. For example, if the bitmap is such that a group of fifteen sub-channels have loadings that are two or more bits greater than the loadings of any other sub-channels, and the disposable bit capacity is such that those high bitload sub-channels can each be decremented by two bits without cutting into the target bitload, then those high bitload sub-channels could be reduced by 2 bits per iteration for a total of fifteen iterations.

Alternatively, those high bitload sub-channels could be each be reduced by 2 bits in a single iteration. Thus, processing time for developing the improved bitloading assignment can be reduced by using a greater than one bit per iteration reduction scheme. However, the given bitmap may make it necessary to perform one bit iterations to ensure an improved bitloading assignment. For example, it may be necessary to perform one bit iterations if all of the sub-channels are within one bit of each other, or the cushion of disposable bit capacity is relatively small (e.g., under 5 bits) and there are large number (e.g., 96) of sub-channels.

The method further includes decrementing 435 the Delta value. This adjustment allows the Delta value to reflect the decremented overall channel loading resulting from decrementing the loading of a particular bin in step 430. The method may also include determining 440 as to whether Delta is greater than zero. If Delta is zero, then the cushion of disposable bit capacity has been utilized and an optimally improved bitloading scheme for that particular channel has been achieved in light of the given parameters (e.g., bₘₐₓ and b_{target}). However, if Delta is greater than zero, then steps 430, 435 and 440 can be repeated until Delta is equal to zero thereby indicating that an optimally improved bitloading has been achieved in accordance with one embodiment of the present invention.

Alternatively, steps 430, 435 and 440 can be repeated until a desired degree of equalization between the sub-channel loadings is achieved. In such an embodiment, although Delta should not go below zero, it need not actually reach zero in order to indicate improved bitloading has been achieved. For example, assume that the improved bitloading assignment for a communication channel having six sub-channels is: 3, 3, 3, 3, 3, and 3 bits. Further assume that the target load (b_{target}) for the channel is 15 bits. Thus, there is a disposable bit capacity (Delta) of 3 bits. However, the bitloading assignment has been completely equalized as all the sub-channels have the same bit loading. In such a case, the service could be upgraded to a b_{target} of 18 bits. Alternatively, the method may simply continue to decrement despite the perfect equalization resulting in a bitloading assignment of, for example, 2, 2, 2, 3, 3, and 3 bits. In another example, assume that the improved bitloading assignment for a communication channel having six sub-channels is: 2, 2, 2, 4, 3, and 2 bits. Further assume that the target load (b_{target}) for the channel is 15 bits. As such, there is a Delta of 0 bits. Further assume that bin four was reduced from 8 bits to 4 bits, while none of the other bin loadings were decremented. Thus, an optimally improved bitloading assignment (given constraints such as the depleted disposable bit capacity) has been achieved in accordance with the present invention.

This method can be carried out, for example, by hardware, software, firmware or any combination thereof. In one embodiment, the method is carried out by codes or a set of instructions executed by a DSP processor. For example, the method could be carried out as part of the functionality of symbol decision/symbol-to-bit decoder 114 and bitloading assignment module 116 (with respect to receive side) and the bit-to-symbol encoder 102 (with respect to transmit side). More specifically, the symbol decision/symbol-to-bit decoder 114 of the receiving transceiver can define the maximum capacity assignment (referred to as initial bitloading assignment herein) of the corresponding channel (e.g., during a bitloading training session). The initial bitloading assignment can then be improved or enhanced by bitloading assignment module 116 in accordance with the method. The resulting bitloading assignment could then be provided to the transmitting transceiver. The bit-to-symbol encoder 102 of the transmitting transceiver could then use the bitloading assignment to perform bitloading. Note the initial bitloading assignment and the resulting bitloading assignment can be developed in the same module (e.g., symbol decision/symbol-to-bit decoder 114 includes the functionality of the bitloading assignment module 116).

Regardless of where the initial bitloading assignment is determined, the method can operate on the initial bitloading assignment thereby producing an improved bitloading assignment for the channel. This improved bitloading assignment can then be used by the likes of bit-to-symbol encoder 102 when performing its bitloading function (e.g., during data mode).

The foregoing description of the embodiments of the invention has been presented for the purposes of illustration and description. It is not intended to be exhaustive or to limit the invention to the precise form disclosed. Many modifications and variations are possible in light of the above teaching. For example, the present invention need not be limited to ADSL Annex C transceivers, but rather can be applied to any transceiver communicating over a multicarrier modulated channel. Once the channel characteristics (e.g., SNR curve) of the multicarrier channel are known, the loading of the individual bins making up that channel can be adjusted in accordance with the present invention. It is intended that the scope of the invention be limited not by this detailed description, but rather by the claims appended hereto.

What is claimed is:

1. A method for identifying a bitloading assignment for a multicarrier communication channel having a number of sub-channels, a maximum capacity assignment, and a disposable bit capacity of one or more bits, the method comprising:
identifying a sub-channel having a maximum bit loading relative to bit loadings of other sub-channels;
decrementing the bit loading of the identified sub-channel by at least one bit thereby reducing bit loading differences between the identified sub-channel and the other sub-channels;
decrementing the disposable bit capacity by the number of bits the identified sub-channel loading was decremented; and
repeating the identifying step and the decrementing steps until a desired degree of equalization between the sub-channel bit loadings is achieved thereby producing a bitloading assignment for the multicarrier communication channel.

2. The method of claim 1, wherein the steps are carried out by a set of codes or instructions executed by a processor included in a transceiver of the multicarrier communication system.

3. The method of claim 1, wherein in response to a number of sub-channels having the same maximum bit loading, the identifying step further includes:
selecting one of the sub-channels having the same maximum bit loading based on a predefined selection scheme.

4. The method of claim 1, wherein the number of bits by which the identified sub-channel loading is decremented depends on at least one of the number of sub-channels of the multicarrier communication channel, the disposable bit capacity of the multicarrier communication channel, and a bitmap associated with the multicarrier communication channel.

5. The method of claim 1, further comprising:
transmitting the bitloading assignment to a remote transceiver operatively coupled to the multicarrier communication channel thereby allowing the remote transceiver to use the bitloading assignment in performing bitloading.

6. The method of claim 1, wherein the desired degree of equalization between the sub-channel bit loadings is achieved when the disposable bit capacity is zero.

7. The method of claim 1, wherein the bitloading assignment produced by the method desensitizes the multicarrier communication channel to non-stationary noise.

8. The method of claim 1, wherein the multicarrier communication channel is realized with an ADSL Annex C transceiver pair coupled to one another via a transmission line.

9. The method of claim 1, wherein the multicarrier communication channel is effectively two different channels, one being a FEXT time channel and the other being a NEXT time channel, each effective channel having a unique maximum capacity assignment upon which the method operates thereby producing a first bitloading assignment for the FEXT channel and a second bitloading assignment for the NEXT channel.

10. The method of claim 1, wherein the maximum capacity assignment of the multicarrier communication channel is derived from a bitmap prepared during a bitloading training session.

11. The method of claim 1, wherein the maximum capacity assignment of the multicarrier communication channel is in the form of a bit vector upon which the method operates.

12. A method for identifying a bitloading assignment for a multicarrier communication channel having a number of sub-channels, the method comprising:
calculating a maximum number of bits that can be transmitted by each sub-channel;
rounding the maximum number of bits that can be transmitted by each sub-channel to the nearest whole bit;
calculating the maximum number of bits that can be transmitted by the multicarrier communication channel based on the rounded maximum number of bits that can be transmitted by each sub-channel;
determining a target load of the multicarrier communication channel thereby defining a disposable bit capacity representing a delta value between the maximum number of bits that can be transmitted by the multicarrier communication channel and the target load of the multicarrier communication channel;
identifying a maximum loaded sub-channel;
decrementing the maximum loaded sub-channel by at least one bit;
decrementing the delta value; and
repeating the identifying step and the decrementing steps until the delta value is zero thereby producing a bitloading assignment that desensitizes the multicarrier communication channel to non-stationary noise.

13. The method of claim 12, wherein the maximum number of bits that can be transmitted by each sub-channel, and the maximum number of bits that can be transmitted by the multicarrier communication channel are derived from a bitmap resulting from a bitloading training sequence, the bitmap characterizing the signal to noise ratio of the multicarrier communication channel.

14. The method of claim 12, wherein the target load of the multicarrier communication channel is based on system configuration options.

15. The method of claim 12, wherein the multicarrier communication channel is realized using digital multi-tone modulation.

16. The method of claim 12, wherein in response to identifying more than one maximum loaded sub-channel thereby requiring a selection to be made, the method further includes:
calculating a round off error for each sub-channel; and
selecting the maximum loaded sub-channel having the greatest round off error.

17. The method of claim 12, wherein in response to identifying more than one maximum loaded sub-channel thereby requiring a selection to be made, the method further includes:
selecting the maximum loaded sub-channel based on a predefined selection scheme.

18. A transceiver for identifying a bitloading assignment for a multicarrier communication channel having a number of sub-channels and a disposable bit capacity of one or more bits, the transceiver comprising:
a bitloading assignment module for equalizing bit loadings of the sub-channels by selectively decrementing high bitload sub-channels until the disposable bit capacity is zero thereby producing a bitloading assignment for the multicarrier communication channel.

19. The transceiver of claim 18, further comprising:
a symbol decision and symbol-to-bit decoder module operatively coupled to the bitloading assignment module and for deriving a maximum capacity assignment from a bitmap that characterizes the multicarrier communication channel.

20. The transceiver of claim 18, wherein the high bitload sub-channels are decremented by a number of bits depending on at least one of the number of sub-channels of the multicarrier communication channel, the disposable bit capacity of the multicarrier communication channel, and a bitmap associated with the multicarrier communication channel.

21. The transceiver of claim 18, wherein the high bitload sub-channels are decremented one bit at a time.

22. The transceiver of claim 18, wherein the disposable bit capacity cannot be below zero as a result of decrementing high bitload sub-channels.

23. The transceiver of claim 18, wherein the bitloading assignment is enhanced in that it desensitizes the multicarrier communication channel to non-stationary noise.

24. The transceiver of claim 18, wherein the multicarrier communication channel is effectively two different channels, one being a FEXT time channel and the other being a NEXT time channel, each effective channel having a unique maximum capacity assignment upon which the bitloading assignment module operates thereby producing a first bitloading assignment for the FEXT channel and a second bitloading assignment for the NEXT channel.

25. The transceiver of claim 18, wherein the bitloading assignment is in the form of a bit vector upon which the bitloading assignment module operates.

26. The transceiver of claim 18, wherein the bitloading assignment module selects a high bitload sub-channel for decrementing based on a predefined selection scheme.

27. A method for identifying a bitloading assignment for an ADSL Annex C multicarrier communication channel having a number of sub-channels, a maximum capacity assignment, and a disposable bit capacity of one or more bits, the method comprising:
identifying a sub-channel having a maximum bit loading relative to bit loadings of other sub-channels;
decrementing the bit loading of the identified sub-channel by at least one bit thereby reducing bit loading differences between the identified sub-channel and the other sub-channels;
decrementing the disposable bit capacity by the number of bits the identified sub-channel loading was decremented; and
repeating the identifying step and the decrementing steps until the disposable bit capacity is zero thereby producing a bitloading assignment that desensitizes the ADSL Annex C multicarrier communication channel to non-stationary noise.

28. A method for identifying a bitloading assignment for an ADSL Annex C multicarrier communication channel having a FEXT channel, a NEXT channel, and an overall target bit capacity, the method comprising:
equalizing bits allocated to the FEXT channel and the NEXT channel until the overall target bit capacity is achieved thereby identifying a target bit capacity for the FEXT channel and a target bit capacity for the NEXT channel;
equalizing bits allocated to sub-channels included in the FEXT channel by:
identifying a sub-channel having a maximum bit loading relative to bit loadings of other sub-channels of the FEXT channel;
decrementing the bit loading of the identified sub-channel by at least one bit thereby reducing bit loading differences between the identified sub-channel and the other sub-channels; and
repeating the identifying step and the decrementing steps until the target bit capacity for the FEXT channel is achieved thereby producing a bitloading assignment that desensitizes the FEXT channel to non-stationary noise;
equalizing bits allocated to sub-channels included in the NEXT channel by:
identifying a sub-channel having a maximum bit loading relative to bit loadings of other sub-channels of the NEXT channel;
decrementing the bit loading of the identified sub-channel by at least one bit thereby reducing bit loading differences between the identified sub-channel and the other sub-channels; and
repeating the identifying step and the decrementing steps until the target bit capacity for the NEXT channel is achieved thereby producing a bitloading assignment that desensitizes the NEXT channel to non-stationary noise.

29. A transceiver for identifying a bitloading assignment for an ADSL Annex C multicarrier communication channel having a FEXT channel, a NEXT channel, and an overall target bit capacity, the transceiver comprising:
a bitloading assignment module adapted to equalize bits allocated to the FEXT channel and the NEXT channel until the overall target bit capacity is achieved thereby identifying a target bit capacity for the FEXT channel and a target bit capacity for the NEXT channel, and the bitloading assignment module further adapted to equalize bits allocated to sub-channels included in the FEXT channel until the target bit capacity for the FEXT channel is achieved thereby producing a bitloading assignment that desensitizes the FEXT channel to non-stationary noise, and the bitloading assignment module further adapted to equalize bits allocated to sub-channels included in the NEXT channel until the target bit capacity for the NEXT channel is achieved thereby producing a bitloading assignment that desensitizes the NEXT channel to non-stationary noise.

30. A method for identifying a bitloading assignment for an ADSL Annex C multicarrier communication channel having a FEXT channel, a NEXT channel, and an overall target bit capacity, the method comprising:
equalizing bits allocated to the FEXT channel and the NEXT channel until the overall target bit capacity is achieved thereby identifying a target bit capacity for the FEXT channel and a target bit capacity for the NEXT channel.

31. A method for identifying a bitloading assignment for an ADSL Annex C multicarrier communication channel having a FEXT channel, a NEXT channel, and an overall target bit capacity, the method comprising:
allocating bits between the FEXT channel and the NEXT channel until the overall target bit capacity is achieved thereby identifying a target bit capacity for the FEXT channel and a target bit capacity for the NEXT channel.
